(19) United States
(12) Patent Application Publication
(10) Pub. No.: US 2025/0220649 A1
(43) Pub. Date: Jul. 3, 2025

(54) WIRELESS DOCK COMMUNICATION CONTROL

(71) Applicant: Cisco Technology, Inc., San Jose, CA (US)

(72) Inventors: Vishal S. DESAI, San Jose, CA (US); Brian D. HART, Sunnyvale, CA (US)

(21) Appl. No.: 18/611,115

(22) Filed: Mar. 20, 2024

Related U.S. Application Data
(60) Provisional application No. 63/616,208, filed on Dec. 29, 2023.

(51) Int. Cl. H04W 72/0453; H04W 4/02; H04W 52/28

(52) U.S. Cl. CPC H04W 72/0453; H04W 4/023; H04W 52/283

(57) ABSTRACT

The present disclosure describes a network (e.g., a Wi-Fi network) that manages and coordinates the communications through wireless docks. An apparatus includes one or more memories and one or more processors communicatively coupled to the one or more memories. A combination of the one or more processors determines, based on a first proximity between (i) an access point and (ii) a first wireless dock and a first device, a first communication frequency that the first wireless dock and the first device should use when communicating with each other and instructs at least one of the first wireless dock or the first device to communicate with each other using the first communication frequency.

### CROSS-REFERENCE TO RELATED APPLICATIONS

This application claims benefit of co-pending U.S. provisional patent application Ser. No. 63/616,208 filed Dec. 29, 2023. The aforementioned related patent application is herein incorporated by reference in its entirety.

### TECHNICAL FIELD

Embodiments presented in this disclosure generally relate to wireless communication. More specifically, embodiments disclosed herein relate to the management of communications involving wireless docks.

### BACKGROUND

Wireless docks are being introduced into offices to manage the connections between user devices (e.g. laptops, phones, computers, etc.) and peripheral devices (e.g., displays, input devices, etc.). The user devices may communicate with the docks and vice versa. For example, a laptop may stream video to a peripheral display through a wireless dock. As the density of offices increases, it is expected that the number of docks and devices in an office environment will also increase. Combined with the increasing popularity of teleconferencing and video streaming, it is expected that the networks in offices will hit spectrum limits and experience more internal interference, which degrade communication quality.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIGS. 1A and 1B illustrate an example system.

FIG. 2 illustrates an example operation performed by the system of FIG. 1A.

FIG. 3 illustrates an example operation performed by the system of FIG. 1A.

FIG. 4 illustrates an example operation performed by the system of FIG. 1A.

FIG. 5 illustrates an example operation performed by the system of FIG. 1A.

FIG. 6 illustrates an example configuration of the system of FIG. 1A.

FIG. 7 is a flowchart of an example operation performed by the system of FIG. 1A.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

The present disclosure describes a network (e.g., a wireless fidelity (Wi-Fi) network) that manages and coordinates the communications between wireless docks and devices. According to an embodiment, an apparatus includes one or more memories and one or more processors communicatively coupled to the one or more memories. A combination of the one or more processors determines, based on a first proximity between (i) an access point and (ii) a first wireless dock and a first device, a first communication frequency that the first wireless dock and the first device should use when communicating with each other and instructs at least one of the first wireless dock or the first device to communicate with each other using the first communication frequency.

According to another embodiment, a method includes determining, based on a first proximity between (i) an access point and (ii) a first wireless dock and a first device, a first communication frequency that the first wireless dock and the first device should use when communicating with each other and instructing at least one of the first wireless dock or the first device to communicate with each other using the first communication frequency.

According to another embodiment, a non-transitory computer readable medium stores instructions that, when executed by a combination of one or more processors, cause the combination of one or more processors to determine, based on a first proximity between (i) an access point and (ii) a first wireless dock and a first device, a first communication frequency that the first wireless dock and the first device should use when communicating with each other and instruct at least one of the first wireless dock or the first device to communicate with each other using the first communication frequency.

### Example Embodiments

The present disclosure describes a network (e.g., a Wi-Fi network) that manages and coordinates communications between wireless docks and devices. Generally, the network determines proximities between access points and groups of wireless docks and devices and sets communication parameters for the docks and devices based on the proximities. For example, the network may instruct the docks and devices to use certain channels, frequencies, bandwidths, and transmission powers when communicating with each other. The network may select the communication parameters to conserve the spectrum on the network and/or to reduce interference.

In particular embodiments, the network provides several technical advantages. For example, the network may conserve spectrum for more access points, devices, and docks. As another example, the network may reduce interference (e.g., interference caused by communication between wireless docks and devices on access points). In this manner, the network improves communication quality.

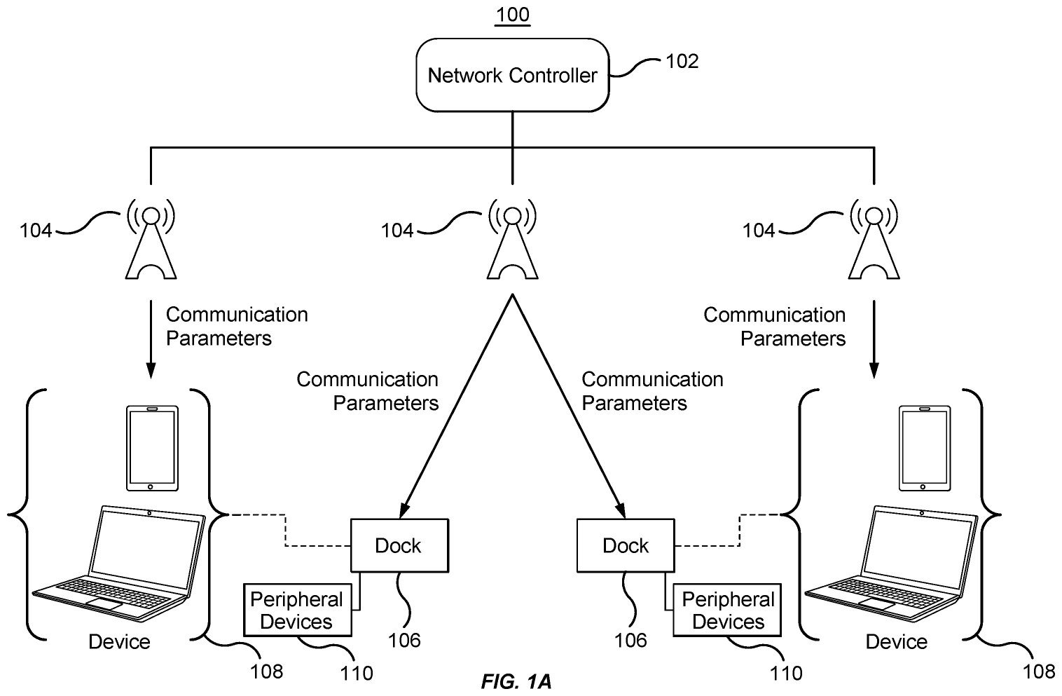

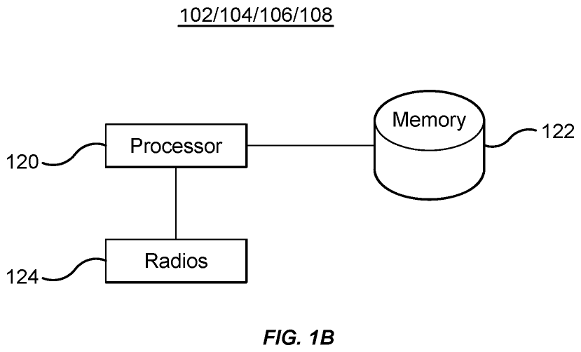

FIG. 1A illustrates an example system 100, which may be a wireless network (e.g., a Wi-Fi network). As seen in FIG. 1A, the system 100 includes one or more network controllers 102, one or more access points 104, one or more wireless docks 106, one or more devices 108, and one or more peripheral devices 110. Generally, the network controller 102 determines proximities in the system 100 (e.g., radio frequency (RF) or physical distances between (i) access points 104 and (ii) docks 106 and devices 108). The network controller 102 then assigns communication parameters to the docks 106 and/or devices 108 based on these proximities to conserve spectrum on the network and/or to reduce interference.

The network controller 102 facilitates or manages the communication in the system 100. For example, the network controller 102 may instruct the docks 106 and/or devices 108 to use certain communication parameters (e.g., channels, frequencies, bandwidths, transmission powers, etc.) when communicating with each other. In some instances, the network controller 102 determines the communication parameters for docks 106 and/or devices 108 to accomplish certain objectives. For example, the network controller 102 may determine the communication parameters so that the docks 106 and/or devices 108 do not consume an excessive amount of the available spectrum on the network. As another example, the network controller 102 may determine the communication parameters so that the docks 106 and/or devices 108 do not interfere with other communications in the system 100 (e.g., other communications from the access points 104 to other docks 106 or devices 108). In some embodiments, the network controller 102 is integrated within one or more of the access points 104.

The access point 104 facilitates wireless communication (e.g., Wi-Fi communication) in the system 100. One or more docks 106 and/or devices 108 may connect to the access point 104. The access point 104 may then facilitate wireless communication for the connected docks 106 and/or devices 108. For example, a dock 106 or device 108 may communicate a message to an access point 104. The access point 104 may route the message towards its destination.

The dock 106 may wirelessly connect a device 108 to peripheral devices 110 (e.g., a display, keyboard, mouse, etc.). Specifically, the device 108 may form a wireless connection with the dock 106. The network controller 102 may set communication parameters for the connections between the docks 106 and the devices 108 (e.g., based on the proximities of the access points 104 to the groups of docks 106 and devices 108). Each dock 106 and device 108 pair then uses these communication parameters to communicate with each other.

The device 108 may be any suitable device that wirelessly connects to the access point 104 and/or a dock 106. As an example and not by way of limitation, the device 108 may be a computer, a laptop, a wireless or cellular telephone, an electronic notebook, a personal digital assistant, a tablet, or any other device capable of receiving, processing, storing, or communicating information with other components of the system 100. The device 108 may be a wearable device such as a virtual reality or augmented reality headset, a smart watch, or smart glasses. The device 108 may also include a user interface, such as a display, a microphone, keypad, or other appropriate terminal equipment usable by the user. The device 108 may include a hardware processor, memory, or circuitry configured to perform any of the functions or actions of the device 108 described herein. For example, a software application designed using software code may be stored in the memory and executed by the processor to perform the functions of the device 108.

In particular embodiments, the network controller 102 determines the proximities between access points 104 and docks 106/devices 108. Generally, each dock 106 and a device 108 connected to that dock 106 are physically close to each other, and so the network controller 102 may treat the dock 106 and the device 108 as a set or group when determining proximities. The proximities determined by the network controller 102 may encompass different concepts related to positioning and distance. For example, the proximities may include the physical distances between the access points 104 and the groups of docks 106 and devices 108. The network controller 102 may determine the physical locations of the access points 104 and the groups of docks 106 and devices 108. For example, the network controller 102 may use global positioning systems to determine the geocoordinates of the access points 104 and the groups of docks 106 and devices 108. The network controller 102 may then determine the physical distances between the access points 104 and the groups of docks 106 and devices 108 using these geocoordinates. As another example, the network controller 102 may have the access points 104 perform ranging techniques (e.g., fine timing measurement (FTM) exchanges, triangulation, and/or techniques based on received signal strength indicators (RSSIs)) to determine the distances between the access points 104 and the groups of docks 106 and devices 108. The access points 104 may also use the distances between the access points 104 and groups of docks 106 and devices 108 to determine the distances between different groups of docks 106 and devices 108 or between groups of docks 106 and devices 108 and other access points 104.

Additionally or alternatively, the proximities may include RF distances between the access points 104 and the groups of docks 106 and devices 108. The RF distance may indicate how a wireless signal is affected when traveling between an access point 104 and a group of docks 106 and devices 108. For example, the access points 104 may measure path loss between the access points 104 and the groups of docks 106 and devices 108. The higher the path loss, the higher the RF distance between an access point 104 and a group of docks 106 and devices 108. As another example, the access points 104, docks 106, and/or devices 108 may provide RSSIs that indicate RF distances.

The network controller 102 then determines the communication parameters for the groups of docks 106 and devices 108 according to the proximities. For example, the network controller 102 may select communication parameters for a dock 106 and device 108 that allows the dock 106 and device 108 to reliably communicate with each other and that conserves spectrum on the network and/or reduces interference with other access points 104. The network controller 102 may then communicate the communication parameters to the dock 106 or device 108 (e.g., through the access point 104). The dock 106 and the device 108 may then communicate with each other according to the communication parameters.

FIG. 1B illustrates an example network controller 102, access point 104, dock 106, and/or device 108 in the system 100 of FIG. 1A. As seen in FIG. 1B, the network controller 102, access point 104, dock 106, and/or device 108 includes a processor 120, a memory 122, and one or more radios 124.

The processor 120 is any electronic circuitry, including, but not limited to one or a combination of microprocessors, microcontrollers, application specific integrated circuits (ASIC), application specific instruction set processor (ASIP), and/or state machines, that communicatively couples to the memory 122 and controls the operation of the network controller 102, access point 104, dock 106, and/or device 108. The processor 120 may be 8-bit, 16-bit, 32-bit, 64-bit or of any other suitable architecture. The processor 120 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor 120 may include other hardware that operates software to control and process information. The processor 120 executes software stored on the memory 122 to perform any of the functions described herein. The processor 120 controls the operation and administration of the network controller 102, access point 104, dock 106, and/or device 108 by processing information (e.g., information received from the memory 122 and radios 124). The processor 120 is not limited to a single processing device and may encompass multiple processing devices contained in the same device or computer or distributed across multiple devices or computers. The processor 120 is considered to perform a set of functions or actions if the multiple processing devices collectively perform the set of functions or actions, even if different processing devices perform different functions or actions in the set.

The memory 122 may store, either permanently or temporarily, data, operational software, or other information for the processor 120. The memory 122 may include any one or a combination of volatile or non-volatile local or remote devices suitable for storing information. For example, the memory 122 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 122, a disk, a CD, or a flash drive. In particular embodiments, the software may include an application executable by the processor 120 to perform one or more of the functions described herein. The memory 122 is not limited to a single memory and may encompass multiple memories contained in the same device or computer or distributed across multiple devices or computers. The memory 122 is considered to store a set of data, operational software, or information if the multiple memories collectively store the set of data, operational software, or information, even if different memories store different portions of the data, operational software, or information in the set.

The radios 124 may communicate messages or information using different communication technologies. For example, the network controller 102, access point 104, dock 106, and/or device 108 may use one or more of the radios 124 for Wi-Fi communications. The network controller 102, access point 104, dock 106, and/or device 108 may use one or more of the radios 124 to transmit messages and one or more of the radios 124 to receive messages. The network controller 102, access point 104, dock 106, and/or device 108 may include any number of radios 124 to communicate using any number of communication technologies.

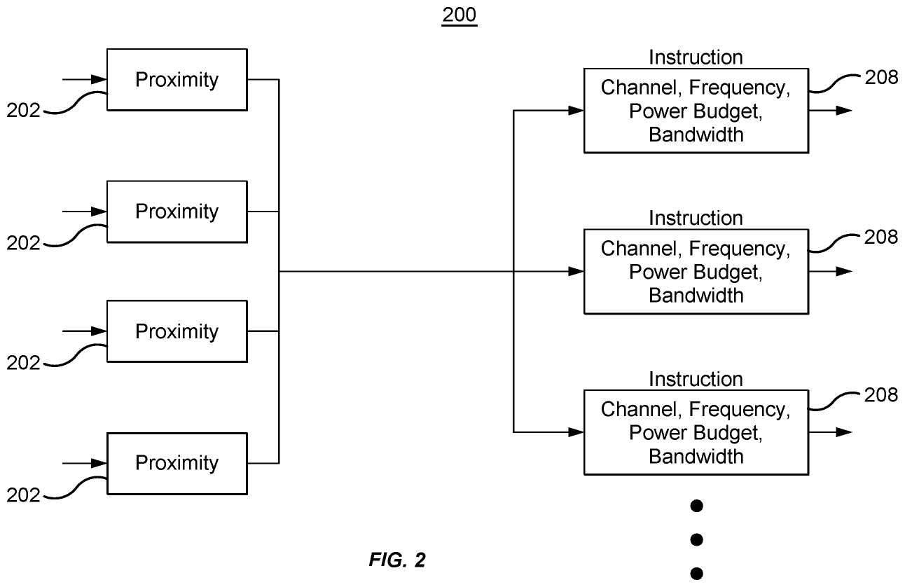

FIG. 2 illustrates an example operation 200 performed by the system 100 of FIG. 1A. Generally, the network controller 102 performs the operation 200. By performing the operation 200, the network controller 102 determines communication parameters for groups of docks 106 and devices 108.

The network controller 102 begins by determining proximities 202 between access points 204 and groups of docks 106 and devices 108. As discussed above, the network controller 102 may use any location technique or ranging technique to determine the proximities 202 as the physical distances between the access points 104 and the groups of docks 106 and devices 108. Additionally or alternatively, the network controller 102 may determine the proximities 202 as the RF distances between the access points 104 and the groups of docks 106 and devices 108. In the example of FIG. 2, the network controller 102 determines the proximities 202. Each of the proximities 202 may be a proximity between an access point 104 and a group including a dock 106 and a device 108. One or more of the proximities 202 may involve the same access point 104. One or more of the proximities 202 may involve the same group of dock 106 and device 108.

Using the proximities 202, the network controller 102 may determine the communication parameters for groups of docks 106 and devices 108. The communication parameters for a group may provide reliable communication between the dock 106 and the device 108 for that group. Additionally, the communication parameters may reduce interference caused by the communications between the dock 106 and the device 108. Furthermore, the network controller 102 may set communication parameters that reduce the spectrum usage of the dock 106 and the device 108. In the example of FIG. 2, the network controller 102 determines a channel, a frequency, a power budget, and a bandwidth that the dock 106 and the device 108 may use. The network controller 102 may determine other communication parameters, such as frequency band, number of channels (e.g., per band), lowest and highest frequencies of the channels, center frequencies of the channels, bandwidths of the channels.

The network controller 102 generates and communicates instructions 208 to the groups of docks 106 and devices 108. The instructions 208 include the communication parameters determined by the network controller 102 for the groups of docks 106 and devices 108. The network controller 102 may generate and communicate any number of instructions 208. Each of the instructions 208 may include different communication parameters depending on the group of dock 106 and device 108 that receives the instruction 208. In this manner, the network controller 102 informs the groups of docks 106 and devices 108 of the communication parameters that the groups of docks 106 and devices 108 should use to communicate with each other. In some embodiments, the instructions 208 are communicated as part of an 802.11 management frame (e.g., an 802.11k neighbor report or an 802.11v channel usage response frame). The frame may indicate the neighboring devices (e.g., neighboring access points 104 and/or docks 106) as well as the communication parameters determined by the network controller 102.

The network controller 102 may communicate an instruction 208 to a group of dock 106 and device 108 through an access point 104. The access point 104 may route the instruction 208 to either of the dock 106 or the device 108. The access point 104 may use any communication protocol or technique (e.g., WiFi, Zigbee, ZWave, Bluetooth, etc.) to communicate the instruction 208 to the dock 106 or device 108. The dock 106 or the device 108 that receives the instruction 208 from the access point 104 then directs the instruction 208 to the connected device 108 or dock 106. The dock 106 and device 108 then implement the communication parameters (e.g., channel, frequency, power budget, bandwidth, etc.) to communicate with each other.

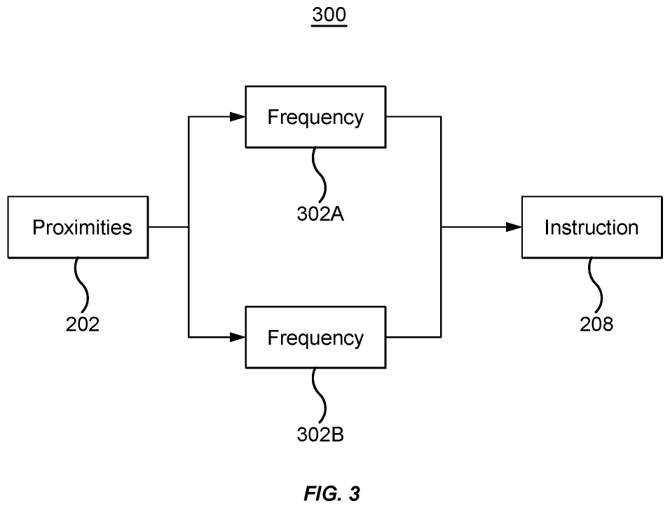

FIG. 3 illustrates an example operation 300 performed by the system 100 of FIG. 1A. Generally, the network controller 102 performs the operation 300. By performing the operation 300, the network controller 102 may instruct a dock 106 and/or device 108 to use multiple frequencies to communicate with each other.

The network controller 102 determines the proximities 202 between access points 104 and groups of docks 106 and devices 108 in the system 100. The network controller 102 uses these proximities 202 to determine how the docks 106 and devices 108 may communicate with each other while conserving spectrum and reducing interference. For example, the network controller 102 may determine one or more frequencies 302 that a dock 106 and device 108 may use to communicate with each other. In the example of FIG. 3, the network controller 102 determines that the dock 106 and the device 108 may use multiple frequencies (e.g., the frequencies 302A and 302B). The frequencies 302A and 302B may be in different frequency domains, which may also be referred to as frequency bands. For example, the frequency 302A may be in the five gigahertz (GHZ) band, while the frequency 302B may be in the six GHz band. The dock 106 and the device 108 may then use the frequencies 302A and 302B to communicate with each other. In some instances, the dock 106 and the device 108 may use both frequencies 302A and 302B simultaneously to communicate with each other.

The network controller 102 generates and communicates the instruction 208 to the dock 106 and/or the device 108. The instruction 208 may indicate the frequencies 302A and 302B. When the dock 106 and/or device 108 receive the instruction 208, the dock 106 and/or device 108 may communicate with each other using one or more of the frequencies 302 indicated in the instruction 208. Using the previous example, if the dock 106 and/or device 108 establish links in both the five GHz and six GHz bands, then the dock 106 and/or device 108 may use both the frequencies 302A and 302B to communicate with each other.

The network controller 102 may consider the proximities 206 between any number of access points 104 and/or docks 106 when determining the communication parameters. For example, the network controller 102 may consider the proximities 206 between other access points 104 and/or docks 106 when determining what frequencies 302 an access point 104 and/or dock 106 should use. In this manner, the network controller 102 considers the layout or topology of the network when determining the communication parameters.

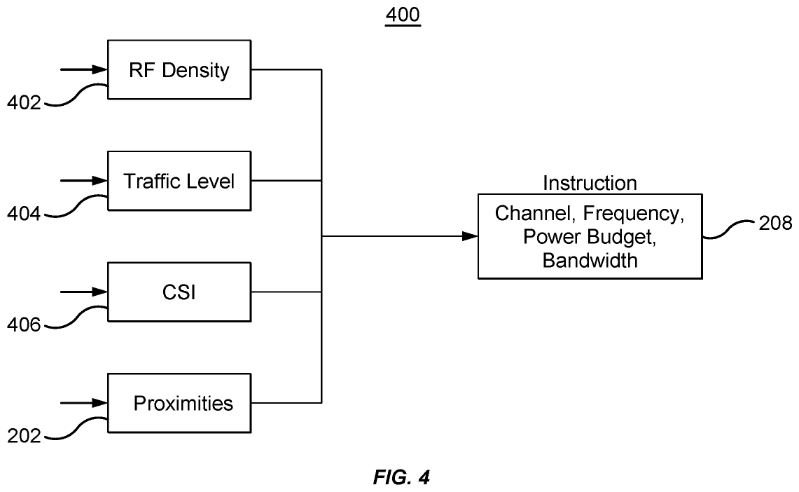

FIG. 4 illustrates an example operation 400 performed by the system 100 of FIG. 1A. Generally, the network controller 102 performs the operation 400. By performing the operation 400, the network controller 102 considers several different factors when determining communication parameters for a dock 106 and device 108.

The network controller 102 may determine certain characteristics of the network at the access points 104, the docks 106, and/or the devices 108. In the example of FIG. 4, the network controller 102 determines a radio frequency (RF) density 402. For example, the network controller 102 may determine the number of access points 104, docks 106, or devices 108 that are near or close by to an access point 104, a dock 106, or device 108. If the number of access points 104, docks 106, or devices 108 is high, then the RF density 402 may similarly be high. If the RF density 402 is high, then the network controller 102 may select communication parameters that reduce interference for the nearby access points 104, docks 106, or devices 108.

The network controller 102 may also determine a traffic level 404. For example, the access point 104, dock 106, or device 108 may report to the network controller 102 the amount of traffic that the access point 104, dock 106, or device 108 is handling. If the traffic level 404 is high (e.g., if the amount of traffic that the docks 106 and devices 108 are communicating to each other are high), then the network controller 102 may select communication parameters that seek to conserve spectrum in the network.

The network controller 102 may determine channel state information (CSI) 406 for the access point 104, dock 106, or device 108. The access point 104, dock 106, or device 108 may perform channel sounding to measure characteristics of the communication medium. For example, the access point 104, dock 106, or device 108 may measure or determine the strength and the reliability of the connections between them. The CSI 406 encapsulates these measured or determined characteristics. For example, the CSI 406 may include RSSIs at certain frequency intervals (e.g., every 20 megaHertz) and/or transmit power used. The network controller 102 may select communication parameters to account for the CSI 406. For example, if the CSI 406 indicates that the connection between the dock 106 and device 108 is not strong, then the network controller 102 may select communication parameters that provide for stronger communications between the dock 106 and the device 108.

As discussed previously, the network controller 102 may consider the proximities 202 between access points 104 and groups of docks 106 and devices 108 in the system 100. These proximities 202 may indicate physical distances and/or RF distances between access points 104 and groups of docks 106 and devices 108. The network controller 102 may select communication parameters that account for the proximities 202. For example, the network controller 102 may select communication parameters that reduce interference between access points 104 and the groups of docks 106 and devices 108.

The network controller 102 may generate and communicate the instruction 208 to a group of a dock 106 and device 108. The instruction 208 includes the communication parameters selected by the network controller 102. In the example of FIG. 4, the instruction 208 indicates a channel, a frequency, a power budget, and a bandwidth that the dock 106 and device 108 should use to communicate with each other. When the dock 106 or device 108 receives the instruction 208, the dock 106 and device 108 may begin communicating with each other using the communication parameters selected by the network controller 102.

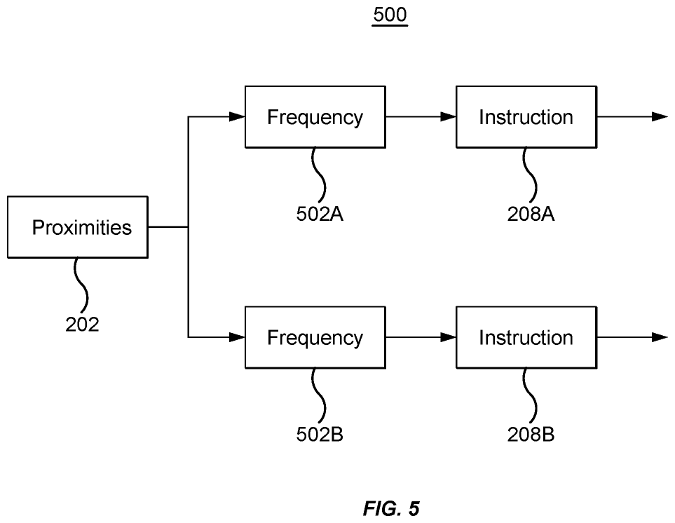

FIG. 5 illustrates an example operation 500 performed by the system 100 of FIG. 1A. Generally, the network controller 102 performs the operation 500. By performing the operation 500, the network controller 102 selects communication parameters for different groups of docks 106 and devices 108.

The network controller 102 determines the proximities 202 between the access points 104 and groups of docks 106 and devices 108 in the system 100. The network controller 102 then determines communication parameters for the groups of docks 106 and devices 108. In the example of FIG. 5, the network controller 102 determines frequencies 502 for multiple groups of docks 106 and devices 108. The network controller 102 may determine different frequencies 502 for different groups. As seen in FIG. 5, the network controller 102 determines a frequency 502A and a frequency 502B. The frequency 502A may be different from the frequency 502B. For example, the frequency 502A may be in a different frequency domain than the frequency 502B. The network controller 102 may also have determined the frequency 502A for a dock 106 and device 108, and the network controller 102 may have determined the frequency 502B for a different dock 106 and device 108.

The network controller 102 generates instructions 208 for the docks 106 and devices. The instructions 208 may indicate the frequencies 502. In the example of FIG. 5, the network controller 102 determines the instruction 208A that indicates the frequency 502A and the instruction 208B that indicates the frequency 502B. The network controller 102 may communicate the instructions 208A and 208B to the different docks 106 and/or devices 108. For example, the network controller 102 may communicate the instruction 208A to a dock 106 and the instruction 208B to a different dock 106. As another example, the network controller 102 may communicate the instruction 208A to a device 108 and the instruction 208B to a different device 108. In some instances, the network controller 102 may communicate the instruction 208A to a dock 106 and the instruction 208B to a device 108. In this manner, the network controller 102 selects different communication parameters (e.g., different frequencies 502) for different groups of docks 106 and devices 108 in the system 100.

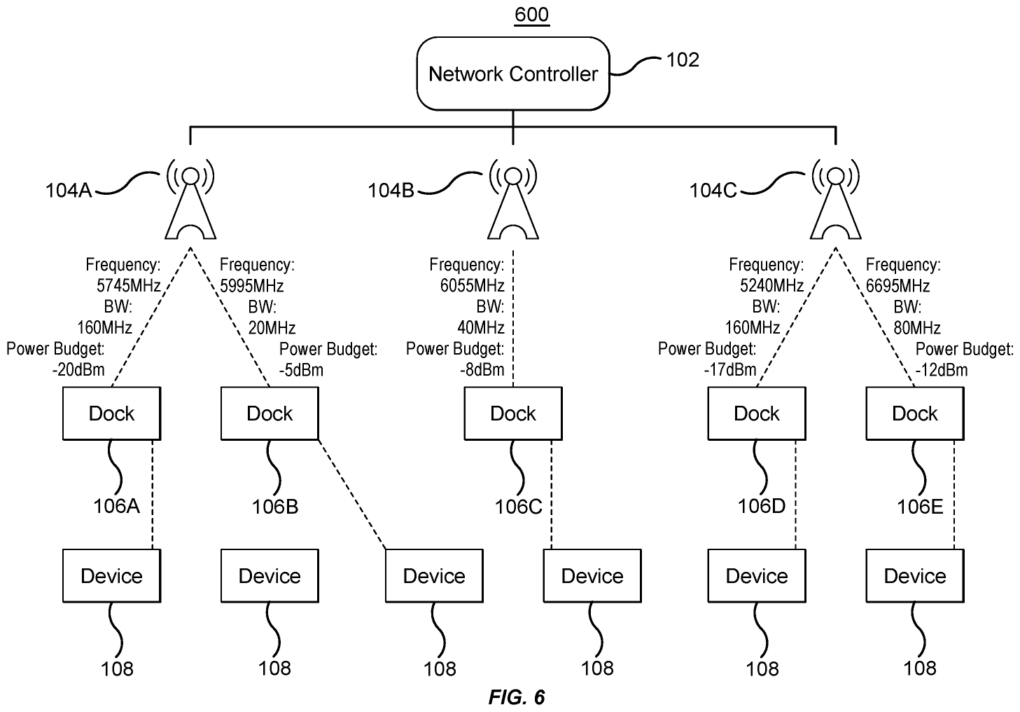

FIG. 6 illustrates an example configuration 600 of the system 100 of FIG. 1. Generally, the configuration 600 includes the network controller 102, access points 104A, 104B, and 104C, docks 106A, 106B, 106C, 106D, and 106E, and devices 108. In the configuration 600, the access points 104 connect to the docks 106 and direct communication parameters from the network controller 102 to the docks 106. The docks 106 may then share the communication parameters with the devices 108 connected to the docks 106. The present disclosure also contemplates other configurations in which the access points 104 connect to the devices 108 and direct communication parameters from the network controller 102 to the devices 108. The devices 108 then share the communication parameters with the docks 106 connected to the devices 108.

The network controller 102 has communicated different communication parameters to the access points 104A, 104B, and 104C and the docks 106A, 106B, 106C, 106D, and 106E. These communication parameters may include different frequencies, different bandwidths, and different power budgets. Even though two docks 106 may communicate through the same access point 104, these docks 106 may still use different frequencies, bandwidths, and/or power budgets to communicate with the devices 108 connected to those docks 106. In some embodiments, the network controller 102 may have selected these communication parameters to conserve spectrum in the network. Additionally, the network controller 102 may have selected these communication parameters to reduce interference between the access points 104 and the groups of docks 106 and devices 108 in the system 100.

As seen in FIG. 6, the access point 104A communicates with docks 106A and 106B. The access point 104A instructs the dock 106A to use the frequency 5745 megahertz (MHz) with a bandwidth of 160 MHZ, and a power budget of −20 dBm. The access point 104A instructs the dock 106B to use the frequency 5995 MHZ, with a bandwidth of 20 MHZ, and a power budget of −5 dBm. The access point 104B communicates with the dock 106C. The access point 104B instructs the dock 106C to use the frequency 6055 MHz, with a bandwidth of 40 MHZ, and a power budget of −8 dBm. The access point 104C communicates with the docks 106D and 106E. The access point 104C instructs the dock 106D to use the frequency 5240 MHZ, with a bandwidth of 160 MHz, and a power budget of −17 dBm. The access point 104C instructs the dock 106E to use the frequency 6695 MHz, with a bandwidth of 80 MHZ, and a power budget of −12 dBm. As a result, the docks 106 use different frequencies, bandwidths, and power budgets to communicate with the devices 108 connected to the docks 106.

Some of the devices 108 may connect to a dock 106 in the configuration 600. The devices 108 connected to the docks 106 communicate with those docks 106 using the communication parameters provided by the access points 104 to which those docks 106 are connected. In some instances, the docks 106 may share the communication parameters with the devices 108 when the devices 108 connect to the docks 106.

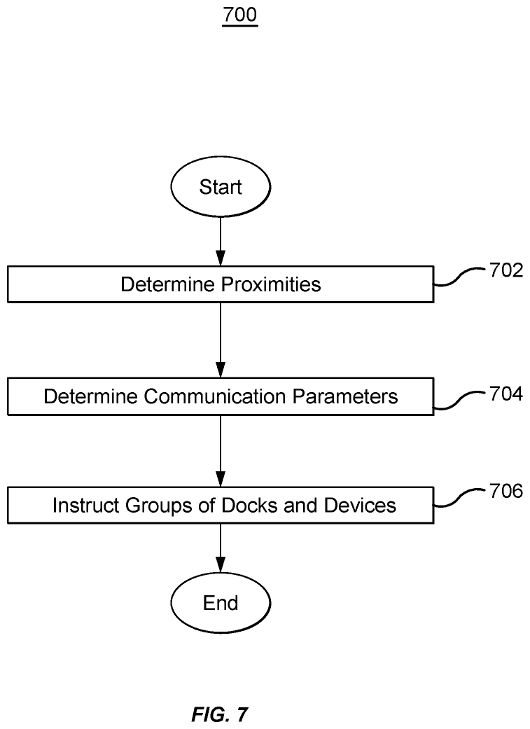

FIG. 7 is a flowchart for an example method 700 performed by the system 100 of FIG. 1A. In particular embodiments, the network controller 102 performs the method 700. By performing the method 700, the network controller 102 selects communication parameters for groups of docks 106 and devices 108 in the system 100.

In block 702, the network controller 102 determines proximities 202 between access points 104 and groups of docks 106 and devices 108. For example, the proximities 202 may indicate the physical distances (e.g., through estimated locations or FTM/ranging) or RF distances (e.g., pathloss or RSSI measurements) between the access points 104 and the groups of docks 106 and devices 108 in the system 100.

In block 704, the network controller 102 determines communication parameters for the groups of docks 106 and devices 108 using the proximities 202. These communication parameters may govern the communications between the docks 106 and the devices 108. For example, the network controller 102 may determine channels, frequencies, power budgets, and bandwidths to be used by the docks 106 and the devices 108 when communicating with each other. The network controller 102 may determine different channels, frequencies, power budgets, and/or bandwidths for different docks 106 and devices 108 in the system 100. The network controller 102 may determine these communication parameters using the proximities 202 between the access points 104 and the groups of docks 106 and devices 108. The proximities 202 may indicate how easy it is for the communication between the docks 106 and their connected devices 108 to interfere with the communications from the access points 104. The network controller 102 may select the communication parameters to conserve the spectrum usage in the network. Additionally, the network controller 102 may select the communication parameters to reduce interference caused by the groups of docks 106 and devices 108.

In block 706, the network controller 102 instructs the groups of docks 106 and devices 108 about the selected or determined communication parameters. For example, the network controller 102 may generate instructions 208 for the groups of docks 106 and devices 108. These instructions 208 may indicate the communication parameters for the groups of docks 106 and devices 108. When a dock 106 or device 108 receives an instruction 208 from the network controller 102, the dock 106 and device 108 may begin communicating with each other using the communication parameters indicated in the received instruction 208.

In summary, the network controller 102 manages and coordinates communications between wireless docks and devices. Generally, the network controller 102 determines proximities between access points 104 and the groups of wireless docks 106 and devices 108 and sets communication parameters for the docks 106 and devices 108 based on the proximities. For example, the network controller 102 may instruct the docks 106 and devices 108 to use certain channels, frequencies, bandwidths, and transmission powers. The network controller 102 may select the communication parameters to conserve the spectrum and/or to reduce interference in the system 100.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. An apparatus comprising:
one or more memories; and
one or more processors communicatively coupled to the one or more memories, a combination of the one or more processors configured to:
determine, based on a first proximity between (i) an access point and (ii) a first wireless dock and a first device, a first communication frequency that the first wireless dock and the first device should use when communicating with each other; and
instruct at least one of the first wireless dock or the first device to communicate with each other using the first communication frequency.

2. The apparatus of claim 1, wherein the combination of the one or more processors is further configured to:
determine, based on the first proximity, a transmission power that the first wireless dock and the first device should use when communicating with each other; and
instruct at least one of the first wireless dock or the first device to communicate with each other using the transmission power.

3. The apparatus of claim 1, wherein the combination of the one or more processors is further configured to determine, based on the first proximity, a second communication frequency to be used by the first wireless dock and the first device to communicate with each other, wherein the second communication frequency is in a different frequency domain than the first communication frequency.

4. The apparatus of claim 1, wherein the combination of the one or more processors is further configured to:
determine, based on the first proximity, a bandwidth that the first wireless dock and the first device should use when communicating with each other; and
instruct at least one of the first wireless dock or the first device to communicate with each other using the bandwidth.

5. The apparatus of claim 1, wherein the combination of the one or more processors is further configured to determine at least one of a radio frequency density at the first wireless dock, a traffic level for the first wireless dock, or channel state information for the first wireless dock, wherein the first communication frequency is determined based on the at least one of the radio frequency density, the traffic level, or the channel state information.

6. The apparatus of claim 1, wherein the first communication frequency is further based on a second proximity between (i) the access point and (ii) a second wireless dock and a second device.

7. The apparatus of claim 1, wherein the combination of the one or more processors is further configured to determine, based on a second proximity between (i) the access point and (ii) a second wireless dock and a second device, a second communication frequency that the second wireless dock and the second device should use when communicating with each other, wherein the first communication frequency is different from the second communication frequency.

8. A method comprising:
determining, based on a first proximity between (i) an access point and (ii) a first wireless dock and a first device, a first communication frequency that the first wireless dock and the first device should use when communicating with each other; and
instructing at least one of the first wireless dock or the first device to communicate with each other using the first communication frequency.

9. The method of claim 8, further comprising:
determining, based on the first proximity, a transmission power that the first wireless dock and the first device should use when communicating with each other; and
instructing at least one of the first wireless dock or the first device to communicate with each other using the transmission power.

10. The method of claim 8, further comprising determining, based on the first proximity, a second communication frequency to be used by the first wireless dock and the first device to communicate with each other, wherein the second communication frequency is in a different frequency domain than the first communication frequency.

11. The method of claim 8, further comprising:
determining, based on the first proximity, a bandwidth that the first wireless dock and the first device should use when communicating with each other; and
instructing at least one of the first wireless dock or the first device to communicate with each other using the bandwidth.

12. The method of claim 8, further comprising determining at least one of a radio frequency density at the first wireless dock, a traffic level for the first wireless dock, or channel state information for the first wireless dock, wherein the first communication frequency is determined based on the at least one of the radio frequency density, the traffic level, or the channel state information.

13. The method of claim 8, wherein the first communication frequency is further based on a second proximity between (i) the access point and (ii) a second wireless dock and a second device.

14. The method of claim 8, further comprising determining, based on a second proximity between (i) the access point and (ii) a second wireless dock and a second device, a second communication frequency that the second wireless dock and the second device should use when communicating with each other, wherein the first communication frequency is different from the second communication frequency.

15. A non-transitory computer readable medium storing instructions that, when executed by a combination of one or more processors, cause the combination of one or more processors to:
determine, based on a first proximity between (i) an access point and (ii) a first wireless dock and a first device, a first communication frequency that the first wireless dock and the first device should use when communicating with each other; and
instruct at least one of the first wireless dock or the first device to communicate with each other using the first communication frequency.

16. The medium of claim 15, wherein the instructions further cause the combination of the one or more processors to:
determine, based on the first proximity, a transmission power that the first wireless dock and the first device should use when communicating with each other; and
instruct at least one of the first wireless dock or the first device to communicate with each other using the transmission power.

17. The medium of claim 15, wherein the instructions further cause the combination of the one or more processors to determine, based on the first proximity, a second communication frequency to be used by the first wireless dock and the first device to communicate with each other, wherein the second communication frequency is in a different frequency domain than the first communication frequency.

18. The medium of claim 15, wherein the instructions further cause the combination of the one or more processors to:
determine, based on the first proximity, a bandwidth that the first wireless dock and the first device should use when communicating with each other; and
instruct at least one of the first wireless dock or the first device to communicate with each other using the bandwidth.

19. The medium of claim 15, wherein the instructions further cause the combination of the one or more processors to determine at least one of a radio frequency density at the first wireless dock, a traffic level for the first wireless dock, or channel state information for the first wireless dock, wherein the first communication frequency is determined based on the at least one of the radio frequency density, the traffic level, or the channel state information.

20. The medium of claim 15, wherein the first communication frequency is further based on a second proximity between (i) the access point and (ii) a second wireless dock and a second device.
